(19) United States
(12) Patent Application Publication
(10) Pub. No.: US 2003/0163524 A1
(43) Pub. Date: Aug. 28, 2003

(54) Information processing system, information processing apparatus, information processing method, and program

(76) Inventors: Hideo Gotoh, Kanagawa (JP); Takashi Masuya, Kanagawa (JP); Yoshio Uratani, Kanagawa (JP)

Correspondence Address: MORRISON & FOERSTER LLP, 1650 TYSONS BOULEVARD, SUITE 300, MCLEAN, VA, 22102, US

(21) Appl. No.: 10/370,114

(22) Filed: Feb. 21, 2003

(30) Foreign Application Priority Data
Feb. 22, 2002 (JP) 2002-047230

(51) Int. Cl. G06F 15/16

(52) U.S. Cl. 709/203

(57) ABSTRACT

A server which connects to a plurality of clients via network, stores contents and a plurality of applications which are authoring tools for editing contents and have different operational conditions from one another in accordance with capacities of hardware and software. The server obtains information indicating capacities of hardware and software of each client and specifies any of the applications that can be operable with the hardware and software of each client. The server provides the specified application to each client. The server also provides contents to the clients in response to requests from the clients.

### BACKGROUND OF THE INVENTION

1. Field of the Invention

The present invention relates to an information processing system, an information processing apparatus, an information processing method, and a program for distributing contents via a network.

2. Description of the Related Art

Contents distribution services for distributing contents such as music and videos through a network have been put into practice. By utilizing this system, one can easily obtain music that can be used as materials of a back ground music (BGM), and videos that can be used as materials of a back ground video (BGV).

However, let a case be assumed where one wants to insert his/her desired sound effects into a music obtained through the above system. In this case, he/she needs to have special devices and special techniques. For example, an authoring tool may be necessary to edit data of music or video. Because hardware and software of editing device (computer, etc) may vary, the authoring tool are generalized application so that it can operate various kinds of editing device. However, generalized authoring tool may not fully utilize performance of each of the editing device, thus editing is performed without using maximum performance of each editing device. In short, editing data of music or video with utilizing the performance of the editing device may be difficult because one can not easily obtain an authoring tool specialized for his/her own editing device's hardware and software.

Therefore, material editing has been complicated and difficult for one who does not have such devices and techniques. In short, conventionally, it has been easy to obtain materials for BGM and BGV, however it has been complicated and difficult to edit the obtained materials and create one's original BGM and BGV.

### SUMMARY OF THE INVENTION

The present invention was made in view of the above circumstance, and an object of the present invention is to provide an information processing system, an information processing apparatus, an information processing method, and a program capable of assisting editing of distributed contents.

To solve the above-described problem, an information processing system according to a first aspect of the present invention is an information processing system which is constituted by a plurality of clients and an information processing apparatus connected to the clients through a network, and which distributes contents from the information processing apparatus to the clients in response to a request, the information processing apparatus comprising: an information storage unit which stores contents and a plurality of applications, the applications being authoring tools for editing the contents, and having different operational conditions from one another in accordance with capacities of hardware and software; and a control unit which distributes contents stored in said information storage unit to said each client in response to the request, obtains information representing capacities of hardware and software of each said client, wherein the control unit: specifies any of the applications operable with the hardware and the software of each said client by an information for specifying the capacities of the hardware and the software of each said client, sent from said each client; and reads out the specified application from said information storage unit, and provides the specified application to each said client.

With this structure, contents and authoring tools for editing the contents, which can be operated on the hardware and software of the client are distributed to each client. Thus creating his/her own BGM, BGV by editing the distributed contents is easy to each user of the clients with the distributed authoring tool.

Said information storage unit may store contents protected by copyrights, and said control unit charges royalty of the contents protected by copyrights to a user identified by an information sent from said client, in case that the user obtains the contents protected by copyrights.

Said information processing apparatus may further comprise a sound conversion unit for converting a quality of a voice represented by a sound data, wherein said control unit obtains a sound data representing a voice of a user of each said client, controls said sound conversion unit to convert the quality of the voice in accordance with an instruction from each said client, and sends converted sound data to instructing client.

Said information processing apparatus may further comprise an automatic translation unit for converting an expression of a voice represented by sound data to predetermined language expression, wherein said control unit obtains the sound data representing a voice of a user of each said client, controls said automatic translation unit to convert the expression of the voice to predetermined language expression in accordance with an instruction from each said client, and sends converted sound data to instructing client.

Said control unit obtains contents edited by one of said clients operating with said application and sent from the one of said clients, stores the contents into said information storage unit, reads out the contents from said information storage unit in accordance with a request from the other of said clients and sends read-out contents to the other of said clients requested obtaining the contents.

To solve the above-described problem according to the second aspect of the present invention is an information processing apparatus connected to a plurality of clients through a network, the information processing apparatus comprise: an information storage unit which stores contents and a plurality of applications, the applications being authoring tools for editing contents and having different operational conditions from one another in accordance with capacities of hardware and software; a control unit which receives device information sent from each said client for specifying capacities of hardware and software of each said client, reads out any of the applications operable with the capacities of the hardware and the software of each said client from said information storage unit based on the received device information, and sends the application to each said client; wherein said control unit: (a) receives content specifying information for specifying a content sent from each said client operating with the transmitted application; and (b) reads out a specific content from said information storage unit based on the received content specifying information; and (c) sends the specified content to each said client.

By employing this structure, an information processing apparatus which distributes not only contents but also authoring tools for editing the distributed contents, is provided. Said information storage unit may store contents protected by copyright and said control unit may charge royalty of the contents protected by copyrights to a user identified by an information sent from said client, in case that the user obtains the contents protected by copyrights.

Said information storage unit may store contents edited by one of said clients operating with the application and sent from the one of said clients, and said control unit reads out stored contents from said information storage unit in response to a request from the other of said clients and sends the read-out contents to the other of said clients.

The information processing apparatus may further comprise a sound conversion unit for converting a quality of a voice represented by a sound data, wherein said control unit: (a) obtains a sound data representing a human voice from each said client; (b) stores the obtained sound data into said information storage unit; (c) reads out the sound data from said information storage unit and give the sound data to said sound conversion unit; (d) controls said sound conversion unit to converts the quality of the voice represented by the sound data in accordance with an instruction sent from each said client; and (e) sends the sound data which has been sound-converted by said first sound conversion means to each said client which has sent the instruction.

The information processing apparatus may further comprise an automatic translation unit for converting an expression of a human voice represented by a sound data to predetermined language expression, wherein said control unit; (a) obtains a sound data representing a human voice from each said client; (b) stores the sound data into said information storage unit; (c) reads out the sound data from said information storage unit in accordance with an instruction sent from each said client and gives the sound data to said automatic translation unit; (d) controls said automatic translation unit to convert the expression of the voice of the read-out sound data to predetermined language expression in accordance with the instruction; (e) sends the sound data which has been sound-converted by said second sound conversion means to each said client which has sent the instruction.

To solve the above-described problem, an information processing method according to a third aspect of the present invention is an information processing method which is applied to an information processing apparatus existing on a network and connected to a plurality of clients through said network, the method comprising: storing contents and a plurality of applications which are authoring tools for editing contents and have different operational conditions from one another in accordance with capacities of hardware and software; obtaining information for specifying capacities of hardware and software of each said client from each said client; specifying any of the applications that is operable with the capacities of the hardware and software of each said client based on the information, and sending the application to each said client; obtaining information for specifying a content from each said client; and sending the content specified by the information to each said client which has sent the information.

According to such a method, contents and an application for editing the contents are distributed from an information processing apparatus to clients. Therefore, editing the distributed contents becomes easier for a user of the each client.

The information processing method may further comprise storing contents protected by copyright, and charging royalty of the contents protected by copyrights to a user identified by an information sent from said client, in case that the user obtains the contents protected by copyrights.

The information processing method may further comprise obtaining sound data representing a human voice from each said client, converting a quality of the voice represented by the sound data in accordance with an instruction sent from each said client which operates in accordance with the application, and sending the converted sound data to each said client which has sent the instruction.

The information processing method may further comprise obtaining sound data representing a human voice from each said client to said information processing apparatus, and converting an expression of said voice to predetermined language expression in accordance with an instruction from each said client which operates in accordance with the application.

The information processing method may further comprise obtaining contents which have been edited by the application and which are sent from one of said clients, storing the contents obtained, obtaining an instruction of sending the contents from the other of said client, and sending the contents to the other of said clients.

To solve the above-described problem, a program according to a fourth aspect of the present invention, is applied to an information processing apparatus connected to a plurality of clients through a network, for distributing a content to said clients at a request, the program controlling said information processing apparatus to execute processes for: obtaining information for specifying capacities of hardware and software of each said client from each said client; specifying any of the applications which are authoring tools for editing contents and have different operational conditions from one another in accordance with capacities of hardware and software, operable with the capacities of the hardware and software of each said client based on the information and sending the application to each said client; obtaining information for specifying a content from each said client; and sending the content specified by the information to each said client which has sent the information.

According to such a program, an information processing apparatus is controlled to distribute not only contents, but also an authoring tool for editing supplied contents which is operable with hardware and software of each client. Thus user of each client edit contents easily with supplied authoring tool.

The program may further control the information processing apparatus to execute processes for: obtaining contents which have been edited by the application and which are sent from one of said clients; storing the contents obtained; obtaining an instruction of sending the contents from the other of said client; and sending the contents to the other of said clients.

The program may further control the information processing apparatus to execute processes for: obtaining sound data representing a human voice from each said client; converting a quality of the voice represented by the sound data in accordance with an instruction sent from each said client which operates in accordance with the application; and sending the converted sound data to each said client which has sent the instruction.

The program may further control the information processing apparatus to execute processes for: obtaining sound data representing a human voice from each said client; converting an expression of said voice to predetermined language expression in accordance with an instruction from each said client which operates in accordance with the application.

The program may further control the information processing apparatus to execute a process for charging royalty of the contents protected by copyrights to a user identified by an information sending from said client, in case that the user obtains the contents protected by copyrights.

To solve the above-described problem, a program according to a fifth aspect of the present invention is an information processing system which is constituted by a plurality of clients and an information processing apparatus connected to said clients through a network, and which distributes contents from said information processing apparatus to said clients in response to a request from said client, said information processing apparatus comprising: means for obtaining information showing capacities of hardware and software of each said client; means for storing a plurality of applications which are authoring tools for editing the contents, and which have different operational conditions from one another in accordance with capacities of hardware and software; and providing means for specifying any of the applications which can be operated on the hardware and software of each client, and providing the specified application to each said client.

With this structure, contents and authoring tools for editing the contents, which can be operated on the hardware and software of the client are distributed to each client. Thus creating his/her own BGM, BGV by editing the distributed contents is easy to each user of the clients with the distributed authoring tool.

To solve the above-described problem according to the sixth aspect of the present invention is an information processing apparatus connected to a plurality of clients through a network, said apparatus comprising: first storage means for storing a plurality of applications which are authoring tools for editing contents and have different operational conditions from one another in accordance with capacities of hardware and software; first reception means for receiving device information for specifying capacities of hardware and software of each said client which information is notified by each said client; first sending means for reading out any of the applications that is operable with by the capacities of the hardware and software of each said client from said first storage means based on the received device information, and sending the application to each said client; second storage means for storing contents; second reception means for receiving content specifying information for specifying a content which information is notified by each said client which operates in accordance with the transmitted application; and second sending means for reading out the specific content from said second storage means based on the received content specifying information, and sending the content to each said client.

By employing this structure, an information processing apparatus which distributes not only contents but also authoring tools for editing the distributed contents, is provided.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a structure of an information processing system according to an embodiment of the present invention;

FIG. 2A is a diagram showing a structure of a client shown in FIG. 1 and FIG. 2B is a block diagram showing a structure of a server shown in FIG. 1;

FIG. 3 is a block diagram showing a structure of an information storage unit shown in FIG. 2B;

FIG. 4 is a block diagram showing a structure of a sound conversion unit shown in FIG. 2B;

FIG. 5 is a block diagram showing a structure of an automatic translation unit shown in FIG. 2B;

FIG. 6A is a diagram showing an example of a top page of a web site for a content distribution service, and FIG. 6B is a diagram showing an example of a process selection screen;

FIG. 7A is a diagram showing an example of a process screen, and FIG. 7B is a diagram showing an example of a screen for operating a demo application;

FIG. 8 is a diagram showing an example of a screen for inputting device information regarding a user terminal;

FIG. 9 is a flowchart for explaining an operation of the information processing system in case of performing a “beginner's course”;

FIG. 10A and FIG. 10B are diagrams showing examples of navigation screens for the “beginner's course”;

FIG. 11 is a flowchart for explaining an operation of the information processing system;

FIG. 12 is a diagram showing an example of a screen showing search results;

FIG. 13A and FIG. 13B are a flowchart for explaining an operation of the information processing system in case of performing a “self-creation course”;

FIG. 14 is a diagram showing an example of a main operation screen for the “self-creation course”;

FIG. 15A and FIG. 15B are diagrams showing examples of navigation screens for BGM or BGV creation;

FIG. 16A and FIG. 16B are diagrams showing examples of navigation screens for BGM or BGV creation;

FIG. 17A is a diagram showing an example of a navigation screen for a sound conversion process, and FIG. 17B is a diagram showing an example of a navigation screen for a language conversion screen; and

FIG. 18 is a diagram showing another example of a structure of the information processing system.

### DETAILED DESCRIPTION OF THE PREFERRED EMBODIMENT

An information processing system, an information processing apparatus, an information processing method, and a program according to an embodiment of the present invention will be explained with reference to the drawings.

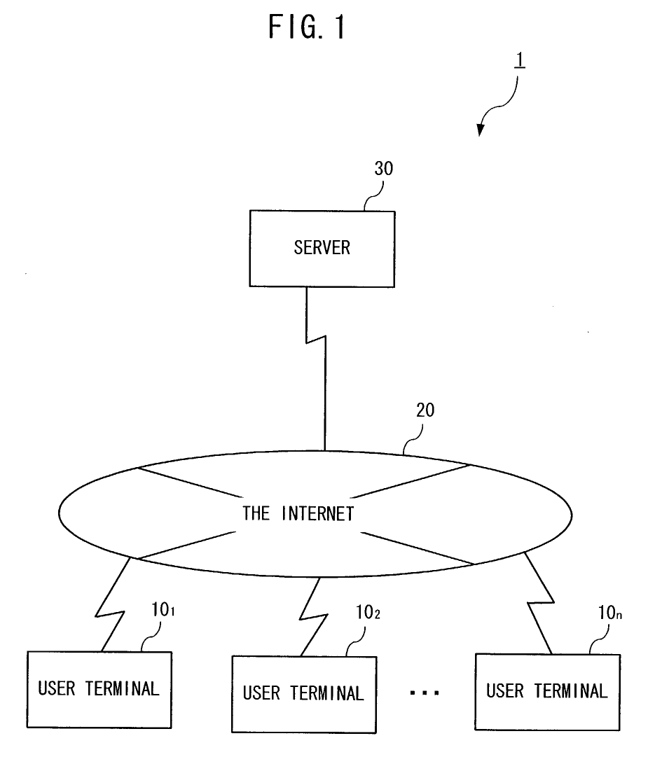

As shown in FIG. 1, the information processing system 1 according to the present embodiment comprises user terminals 10₁ to 10ₙ (n represents the total number of user terminals) and a server 30 exiting on a network such as the Internet 20 and connecting to the user terminals 10₁ to 10ₙ. The user terminals 10₁ to 10ₙ create background music (hereinafter referred to as BGM) and background video (hereinafter referred to as BGV) in accordance with user's operations. The server distributes contents such as music and video to be used as materials for BGM and BGV to the user terminal 10₁ to 10ₙ through the network in accordance with requests from the user terminals 10₁ to 10ₙ, and provides an application for assisting the user terminals 10₁ to 10ₙ in creating BGM and BGV.

Hereinafter, the user terminals 10₁ to 10ₙ are represented by a user terminal 10.

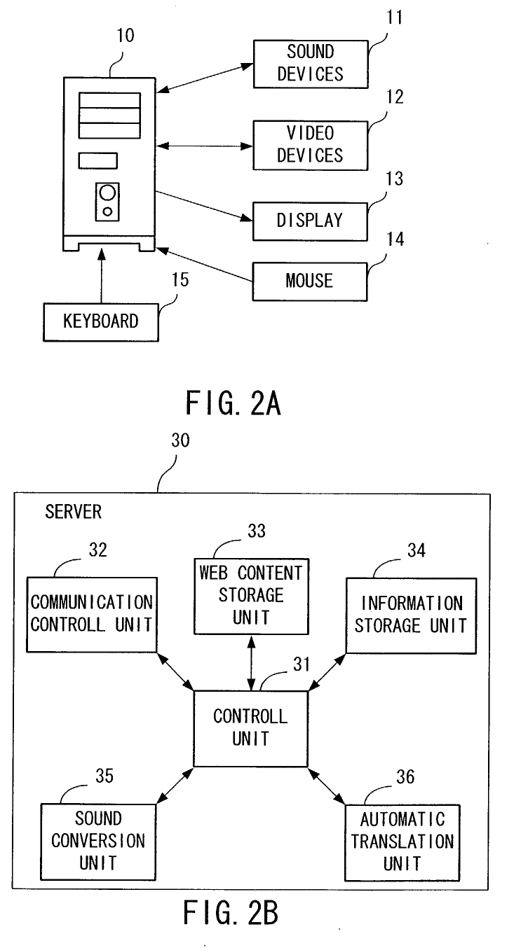

The user terminal 10 is constituted by a general computer which comprises a hard disk drive (hereinafter referred to as HDD), a memory, a sound card, a video card, and a modem card, etc. As shown in FIG. 2A, the user terminal 10 further comprises: sound devices 11 including a microphone, a speaker, etc; video devices 12 including a digital camera, digital video camera, etc; a display 13; a mouse 14; a keyboard 15. The user terminal 10 is connected to the server 30 through the network. The user terminal 10 includes a web browser. The capacities of hardware and software of each user terminal 10 are varied.

Next, the structure of the server 30 will be explained.

The server 30 is constituted by a general-purpose computer. As shown in FIG. 2B, the server 30 comprises a control unit 31, a communication control unit 32, a web content storage unit 33, an information storage unit 34, a sound conversion unit 35, an automatic translation unit 36.

The control unit 31 is constituted by a CPU (Central Processing Unit) controlled by a program, and controls the elements of the server 30. The control unit 31, the communication control unit 32, the sound conversion unit 35, and the automatic translation unit 36 which are to be described later, operate in accordance with programs (not shown) stored in a non-illustrated RAM (Random Access Memory), non-illustrated ROM (Read Only Memory) included in the server 30.

The communication control unit 32 establishes connection between the user terminal 10 and the server 30 on the internet 20, and allows data exchange between the user terminal 10 and the server 30 in accordance with a predetermined protocol (for example, HTTP, FTP).

The web content storage unit 33 stores HTML files, etc. for opening a web site for the content distribution service on the World Wide Web.

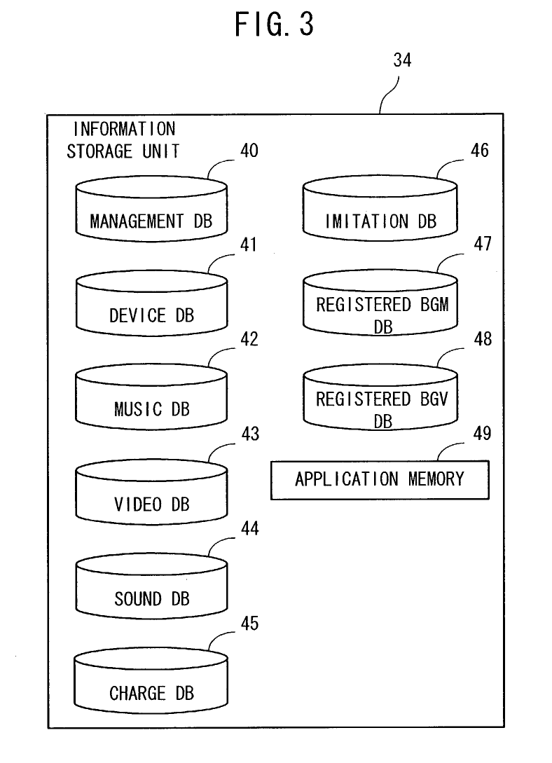

As shown in FIG. 3, the information storage unit 34 includes a management database (hereinafter referred to as DB) 40, a device DB 41, a music DB 42, a video DB 43, a sound DB 44, a charge DB 45, an imitation sound DB 46, a registered BGM DB 47, a registered BGV DB 48, and an application memory 49.

The management DB 40 stores data (member data) such as a member ID, a password, information necessary to contact a member (for example, address, name, phone number, etc.), a method of paying a charge for using this system, etc. The device DB 41 stores device information regarding the user terminal 10, such as type of hardware, type of operating system, etc. The music DB 42 stores data representing music protected by copyrights which are sorted by titles, singers, alphabetical order, and genres, and also stores a list of music recommended and updated daily, weekly, and monthly by the organizer of the server 30.

The video DB 43 stores video data protected by copyrights which are sorted by alphabetical order and genres. The sound DB 44 stores data representing sounds (hereinafter referred to as sound data) which is not subject to copyright protection, such as narration, shouting voice, laughing voice, and sound data representing user's voice which are uploaded from the user terminal 10, etc. The charge DB 45 stores data of download log, etc., for charging royalty of contents protected by copyrights (or broadcasting rights) to users who obtain the contents protected by copyrights.

The imitation sound DB 46 stores data representing daily sounds such as car engine sounds, airplane engine sounds, phone ringing, etc., nature sounds such as winds, waves, murmuring of streams, birds, insects, etc., and sound effects such as hand clapping, booing, etc. The registered BGM DB 47 stores BGM data created by a user and forwarded from the user terminal 10. The registered BGV DB 48 stores BGV data created by a user and forwarded from the user terminal 10.

The application memory 49 stores a demonstration application, a BGM creation assist application, and a BGV creation assist application.

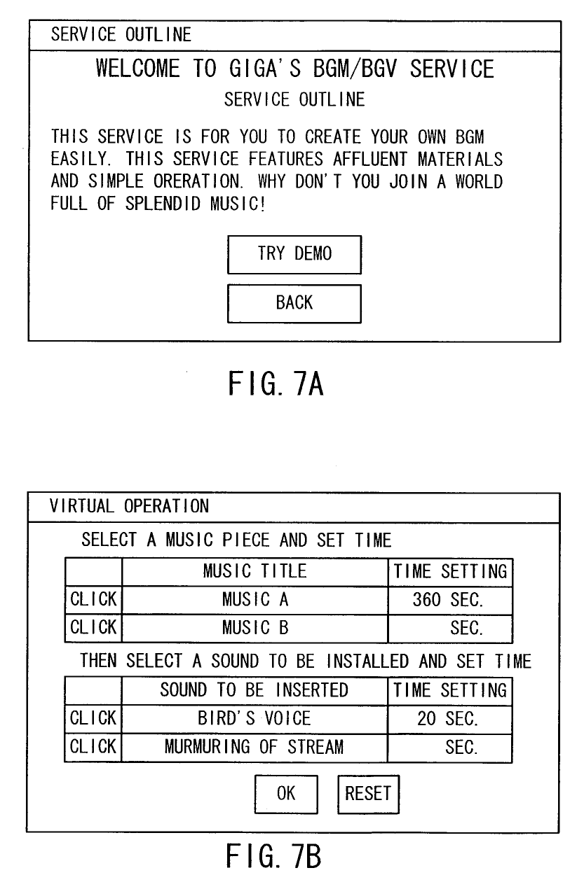

The demonstration application (hereinafter referred to as demo application) is a trial version of the BGM creation assist application, and provided to the user terminal 10 at the request from the user terminal 10. The demo application has a part of functions of BGM creation assist application. This application is an authoring tool for users who do not have memberships of the contents distribution service provided by the organizer of the server 30. FIG. 7B shows one example of a screen of the demo application. According to this demo application, either one of a bird's voice and murmuring of a stream can be inserted into either one of a music A and a music B.

The BGM creation assist application and the BGV creation assist application are authoring tools to be provided to the user terminal 10 at the request of the user terminal 10. Those applications have varieties, each have different operational conditions from one another in accordance with capacities of hardware and software. The user terminal 10 send information for specifying capacities of hardware and software thereof to the server 30, then user terminal obtain an appropriate variety of application which operates with the user terminal 10's hardware and software. The user terminal 10 can use the following services provided by the organizer of the server 30, only with using these applications.

1) downloading of music data and video data from the server 30 to the user terminal 10

2) downloading of sound data and video data from the server 30 to the user terminal 10

3) registration of sound data to the server 30 from the user terminal 10

4) creation of BGM data and BGV data

5) sound conversion of sound data

6) language conversion of sound data

7) data reproduction (play)

8) data uploading from the user terminal 10 to the server 30

9) downloading of BGM data and BGV data from the server 30 to the user terminal 10

In the following explanation, the BGM creation assist application and the BGV creation assist application will be collectively referred to as BGM/BGV creation assist application. The operation of the information processing system 1 when using the BGM/BGV creation assist application will be explained in detail later.

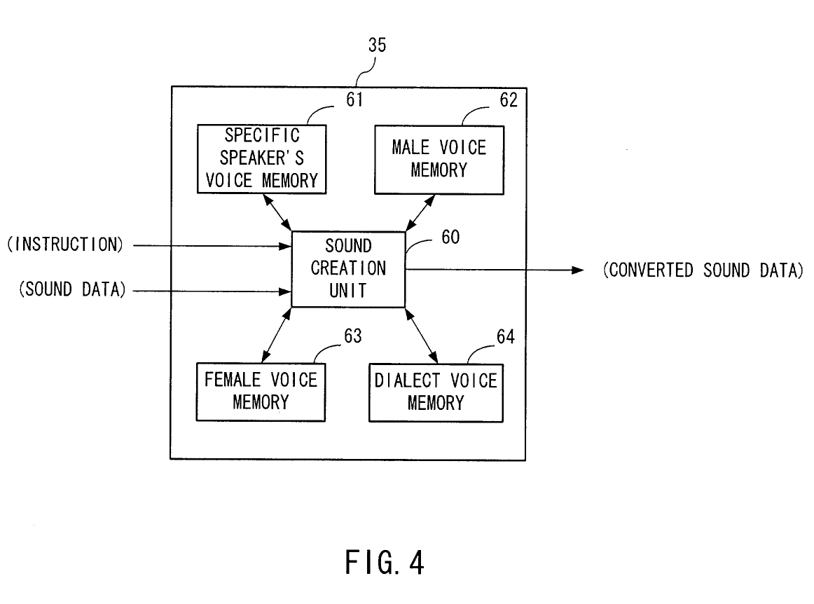

As shown in FIG. 4, the sound conversion unit 35 shown in FIG. 2B includes a sound creation unit 60, a specific speaker's voice memory 61, a male voice memory 62, and a female voice memory 63 and a dialect voice memory 64.

The sound creation unit 60 converts a sound represented by sound data sent from the control unit 31 into a voice of a specific speaker (famous actor, etc.), a male voice, a female voice, or a predetermined dialect voice, in accordance with an instruction from the control unit 31. The sound creation unit 60 sends the sound data subjected to the sound conversion to the control unit 31.

The specific speaker's voice memory 61 stores sound data representing a specific speaker's voice and codes correspondingly assigned to the specific speaker's voice.

The male voice memory 62 store sound data representing a redetermined man's voice and codes correspondingly assigned to he predetermined man's voice.

The female voice memory 63 stores sound data representing a predetermined woman's voice and codes correspondingly assigned to the predetermined woman's voice.

The dialect voice memory 64 stores sound data representing a predetermined dialect's pronunciation and codes correspondingly assigned to the predetermined dialect.

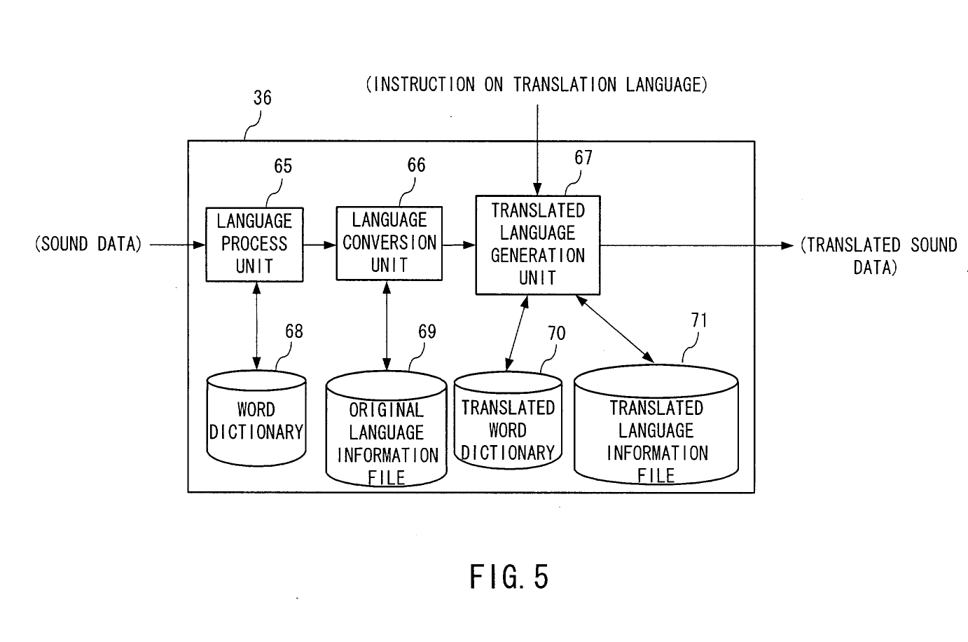

As shown in FIG. 5, the automatic translation unit 36 shown in FIG. 2B includes a language process unit 65, a language conversion unit 66, a translated language generation unit 67, a word dictionary 68, an original language information file 69, a translated word dictionary 70, and a translated language information file 71. The automatic translation unit 36 converts sound data stored in the sound DB 44 into sound data representing a predetermined language specified by a user.

The language process unit 65 recognizes a plurality of words in sound data sent from the control unit 31, by referring to the word dictionary 68.

The language conversion unit 66 analyzes sentence constructions and meanings of the words recognized by the language process unit 65, by referring to language rules stored in the original language information file 69. Further, the language conversion unit 66 converts the plurality of analyzed words into a word stream that makes sense.

The translated language generation unit 67 converts the word stream obtained by the language conversion unit 66 into a word stream of a predetermined language, by referring to the translated word dictionary 70 of the predetermined language, in accordance with an instruction from the control unit 31. Further, the translated language generation unit 67 rearranges the obtained word stream into a word stream that makes sense in the predetermined language, by referring to language rules of the predetermined language stored in the translated language information file 71. Then, the translated language generation unit 67 sends the obtained word stream to the control unit 31.

Next, operations of the information processing system 1 according to the present embodiment will be explained.

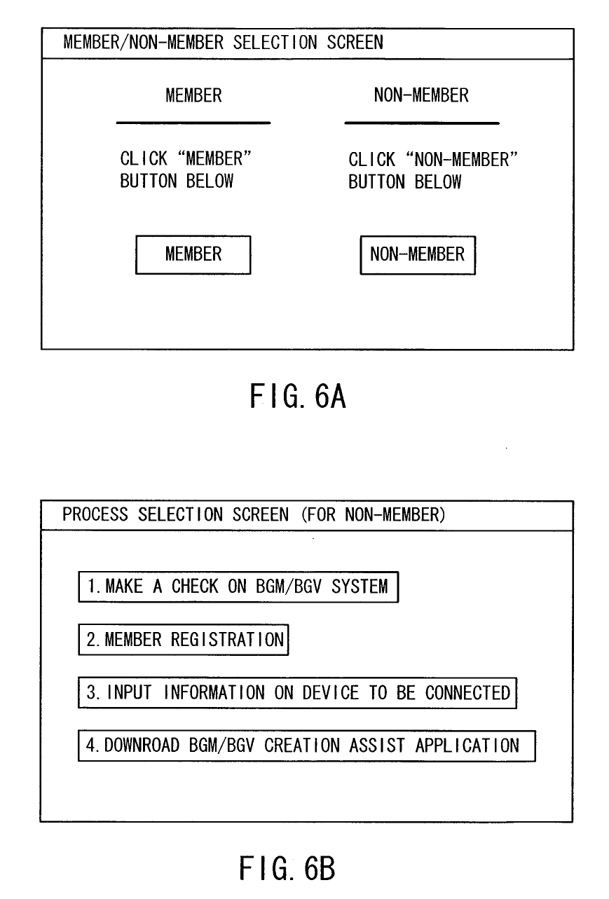

First, an operation for sending the demonstration application for a non-member to the user terminal 10 from the server 30, will be explained with reference to FIG. 6 and FIG. 7. In this example, it is assumed that a user wishes to have a membership of the content distribution service provided by the organizer of the server 30.

When the user gives an instruction for browsing the top page of the web site of the content distribution service from the user terminal 10, this instruction is transmitted to the control unit 31 of the server 30 via the Internet. In response to this instruction, the control unit 31 stores the IP address of the sender of this instruction. Next, the control unit 31 reads out screen data shown in FIG. 6A for prompting the user to select whether he/she is a member or a non-member from the web content storage unit 33, and sends the data to the stored IP address, i.e., the user terminal 10.

The user terminal 10 receives this data, and displays the screen shown in FIG. 6A on the display 13. Since the user has not yet completed the registration procedure, he/she selects that he/she is a non-member (clicks a “non-member” button using the mouse 14 of the user terminal 10). The user terminal 10 notifies the control unit 31 of the server 30 that the user has selected (clicked) the “non-member” button.

In response to this notification, the control unit 31 reads out data representing a process selection screen (for non-member) shown in FIG. 6B from the web content storage unit 33. Then, the control unit 31 sends the read-out data to the user terminal 10.

The user terminal 10 receives the data, and displays the process selection screen shown in FIG. 6B on the display 13. Then, the user clicks “1. Make a check on BGM/BGV system” in the process selection screen shown in FIG. 6B, using the mouse 14 of the user terminal 10. The user terminal 10 notifies this selection to the control unit 31 of the server 30.

In response to this notification, the control unit 31 reads out data representing a check screen shown in FIG. 7A including a “try demo” button and a “back” button from the web content storage unit 33, and sends the data to the user terminal 10.

The user terminal 10 receives this data, and displays the screen shown in FIG. 7A on the display 13. In this example, it is assumed that the user wishes to try the demo. If the user clicks the “back” button in the screen using the mouse 14 of the user terminal 10, the user terminal 10 displays the screen shown in FIG. 6B on the display 13 again.

When the user clicks the “try demo” button using the mouse 14 of the user terminal 10, the user terminal 10 notifies the control unit 31 of the server 30 that the user has clicked the “try demo” button.

In response to this notification, the control unit 31 reads out the demo application from the application memory 49. Then the control unit 31 sends the read-out demo application to the user terminal 10.

The user terminal 10 receives the demo application. After downloading is finished, the demo application automatically starts. The user terminal 10 displays a virtual operation screen shown in FIG. 7B on the display 13 in accordance with the demo application. The user selects “music A” and “bird's voice” using the mouse 14 of the user terminal 10, and clicks an “OK” button. The user terminal 10 notifies the control unit 31 of the server 30 that the user has selected “music A” and “bird's voice”.

In response to this notification, the control unit 31 searches the music DB 42 for the data of the “music A”. Then, the control unit 31 reads out the data of the searched music, i.e., the “music A” from the music DB 42. Next, the control unit 31 searches the imitation sound DB 46 for the data of the “bird's voice”. Then, the control unit 31 reads out the data of the “bird's voice” from the imitation sound DB 46. Then, the control unit 31 sends the data of the “music A” and the data of the “bird's voice” to the user terminal 10.

The user terminal 10 receives these data, and reproduces these data in accordance with the demo application (plays the “music A” with inserting “bird's voice”). After the play is finished, the user terminal 10 erases the virtual operation screen shown in FIG. 7B from the display 13, and displays the process selection screen shown in FIG. 6B again.

If the user click the “member” button of the member/non-member selection screen shown in FIG. 6A, the control unit 31 of the server 30 responds this, reads out data representing a screen (not shown) for changing his/her membership information (for example, registered address), from the web content storage unit 33. The control unit 31 sends the data to the user terminal 10. The user terminal 10 receives the data, and display the screen on the display 13. The user having a membership can change his or/her member information from the screen.

Next, an operation of the information processing system 1 when the user performs a member registration procedure, will be explained. When the user clicks a “2. Member registration” button in the screen shown in FIG. 6B, this selection is notified to the control unit 31 of the server 30.

In response to this notification, the control unit 31 reads out data representing a screen for prompting the user to input the user's address, name, and phone number, pay method, and a desired password, etc. from the web content storage unit 33, and sends the data to the user terminal 10.

The user terminal 10 receives this data and displays the screen for member registration on the display 13. When the user inputs predetermined personal information, etc. on the screen by operating the user terminal 10, the user terminal 10 sends the input information to the control unit 31 of the server 30.

The control unit 31 generates member data, assigns an ID number to the generated member data, and stores the member data with the assigned ID number in the management DB 40. The control unit 31 also stores the data of the assigned member ID in the device DB 41. Then, the control unit 31 notifies the assigned member ID to the user terminal 10. In response to this notification, the user terminal 10 displays the member ID on the display 13. Successively, the user terminal 10 displays the process selection screen shown in FIG. 6B on the display 13 again in accordance with an operation of the user.

The member registration may be carried out by email, etc,.

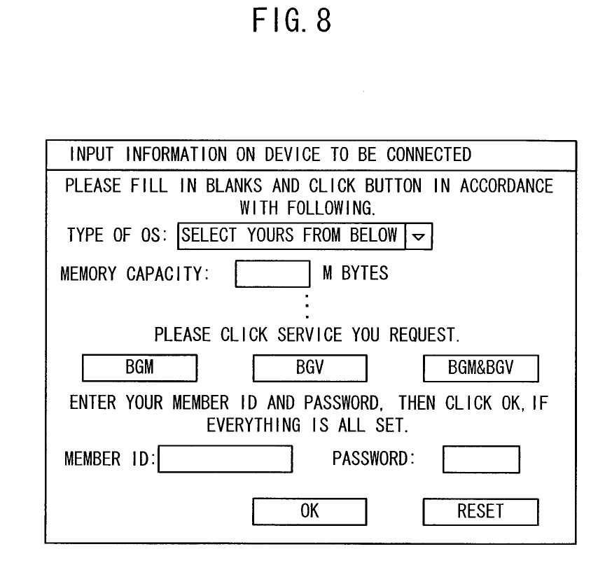

Next, an operation for obtaining device information regarding the user terminal 10 will be explained with reference to FIG. 6B and FIG. 8.

First, the user clicks “3. Input information on the device to be connected” button in the screen shown in FIG. 6B, using the mouse 14 of the user terminal 10. The user terminal 10 notifies the control unit 31 of the server 30 that the user has selected “3. Input information on the device to be connected”.

In response to this notification, the control unit 31 reads out data representing a screen shown in FIG. 8 for prompting the user to input device information on the user terminal 10 (type of the operating system, memory capacity, etc. of the user terminal 10), member ID, and password from the web content storage unit 33, and sends the data to the user terminal 10.

The user terminal 10 receives this data, and displays the screen shown in FIG. 8 on the display 13. The user inputs device information on the user terminal 10 to the screen by using the mouse 14, the keyboard 15 of the user terminal 10. After inputting the device information, the user selects a service he/she prefers. In a case the user wants to use a service for BGM only, the user clicks a “BGM” button in the screen using the mouse 14. In a case where the user wants to use a service for BGV only, the user clicks a “BGV” button in the screen using the mouse 14. In a case where the user wants to use a service for both BGM and BGV, the user 15 clicks a “BGM&BGV” button in the screen using the mouse 14. The user further operates the user terminal 10 to input his/her member ID and password to the screen.

When the user clicks an “OK” button by the mouse 14, the user terminal 10 sends the input information to the control unit 31 of the server 30.

The control unit 31 receives the information, and searches for a member ID and password corresponding to the received member ID and password in the management DB 40. The control unit 31 reads out member data associated with the member ID and password which have been searched out. The control unit 31 stores this member data in association with information on the service the user has selected in the management DB 40. Further, the control unit 31 reads out the data of the member ID from the device DB 41, and stores the device information in association with the read-out member ID in the device DB 41. The control unit 31 notifies the user terminal 10 that this series of processes has been completed. In response to this notification, the user terminal 10 displays a message such as “registration of the device information has been completed” on the display 13. Then, the user terminal 10 displays the process selection screen shown in FIG. 6B on the display 13 again.

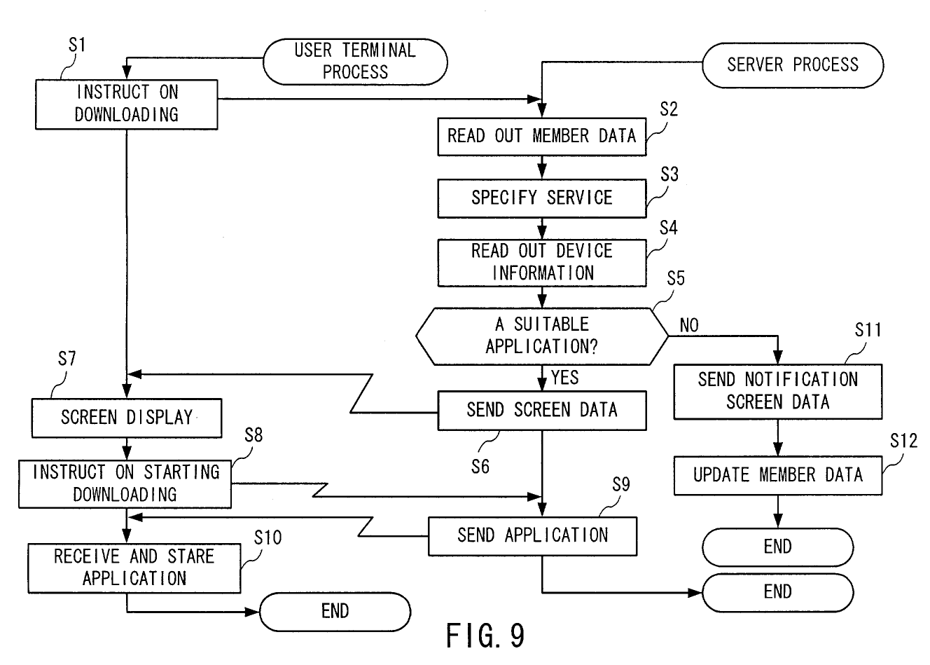

Next, an operation for downloading the BGM/BGV creation assist application to the user terminal 10 from the server 30 will be explained with reference to FIG. 6B and FIG. 9. The right hand of FIG. 9 shows processes performed by the control unit 31 of the server 30, and the left hand shows processes performed by the user terminal 10.

By the user's clicking “4. Download the BGM/BGV creation assist application” button in the screen shown in FIG. 6B using the mouse 14 of the user terminal 10, the user terminal 10 instructs the control unit 31 of the server 30 to supply data of the BGM/BGV creation assist application (step S1).

In response to this instruction, the control unit 31 reads out the member data from the management DB 40 (step S2), and specifies the service requested by the user (step S3). Next, the control unit 31 reads out the device information of the user terminal 10 from the device DB 41 (step S4).

The control unit 31 determines whether or not there is any BGM/BGV creation assist application which can be operable with the capacities of the hardware and software of the user terminal 10, based on these read-out information (step S5). When determining that there is an application suitable for the user terminal 10 (step S5; YES), the control unit 31 sends data representing a screen for prompting the user to give an instruction to start downloading the application, to the user terminal 10 (step S6).

The user terminal 10 receives this data, and displays the screen for prompting the user to give an instruction to start downloading on the display 13 (step S7). When the user instructs to start downloading from the user terminal 10 (step S8), this instruction is transmitted to the control unit 31 of the server 30. In response to this instruction, the control unit 31 sends the BGM/BGV creation assist application to the user terminal 10 (step S9). The user terminal 10 receives the BGM/BGV creation assist application from the server 30, and stores it in the HDD (step S10). After download is completed, the user terminal 10 finishes the process. On the other hand, when sending of the BGM/BGV creation assist application is completed, the control unit 31 of the server 30 reads out the member data from the management DB 40, and updates the member data by additionally writing that downloading of the BGM/BGV creation assist application has been performed. Then, the control unit 31 completes the process.

On the contrary, when determining in step S5 that there is no BGM/BGV creation assist application that can be operable with the capacities of the hardware and software of the user terminal 10 (step S5; NO), the control unit 31 then notifies the user terminal 10 that there is no “appropriate application” with reasons (step S11). In response to this notification, the user terminal 10 displays a message such as “there is no BGM/BGV creation assist application suitable for your OS” on the display 13. Next, the control unit 31 reads out the member data from the management DB 40, and updates the member data by additionally writing that there is no suitable BGM/BGV creation assist application (step S12). Then, the control unit 31 completes the process.

A case that some of the users can not obtain proper applications would be avoided if the organizer of the server 30 check the reason from the updated member data, and create an appropriate BGM/BGV creation assist application immediately.

Next, an operation when the user uses the BGM/BGV creation assist application will be explained.

First, the user operates the user terminal 10 for starting the BGM/BGV creation assist application. The user terminal 10 displays a screen for prompting the user to input his/her member ID and password on the display 13 in accordance with the BGM/BGV creation assist application. The user operates the user terminal 10 and inputs his/her member ID and password. The user terminal 10 sends the information input by the user's operation to the control unit 31 of the server 30.

The control unit 31 receives the information. The control unit 31 searches for a member ID and password corresponding to the member ID and password input by the user in the management DB 40. Based on this searching, the control unit 31 determines whether or not the member ID and password input by the user are registered in the management DB 40.

When the control unit 31 determines that the member ID and password are registered in the management DB 40, i.e., that the member ID and password are valid, the control unit 31 notifies the user terminal 10 of this determination.

On the other hand, in a case where the control unit 31 determines that the member ID and password are not registered in the management DB 40, the control unit 31 notifies the user terminal 10 of the fact. In a case where receiving a notification that the member ID and password are not registered, the user terminal 10 displays a message such as “the member ID and password you have input are not registered” on the display 13 in accordance with the application.

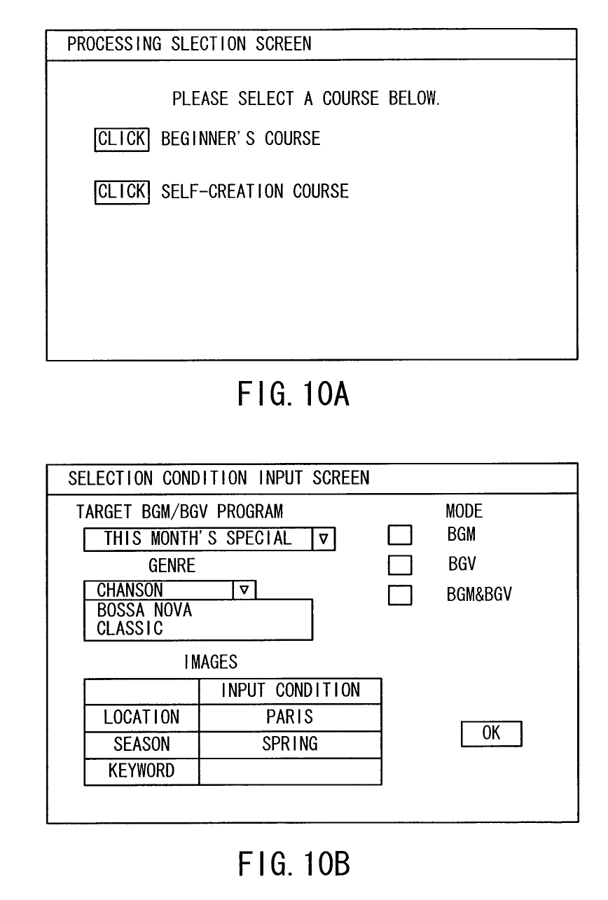

On the other hand, in a case where receiving a notification that the member ID and password are registered, the user terminal 10 displays a job selection screen shown in FIG. 10A on the display 13 in accordance with the application. The user can get down to his/her job utilizing one of a “beginner's course” and a “self-creation course” on this job selection screen. Whether to select the “beginner's course” or the “self-creation course” is up to the user. The user inputs an instruction on which course to use to the user terminal 10.

(Beginner's Course)

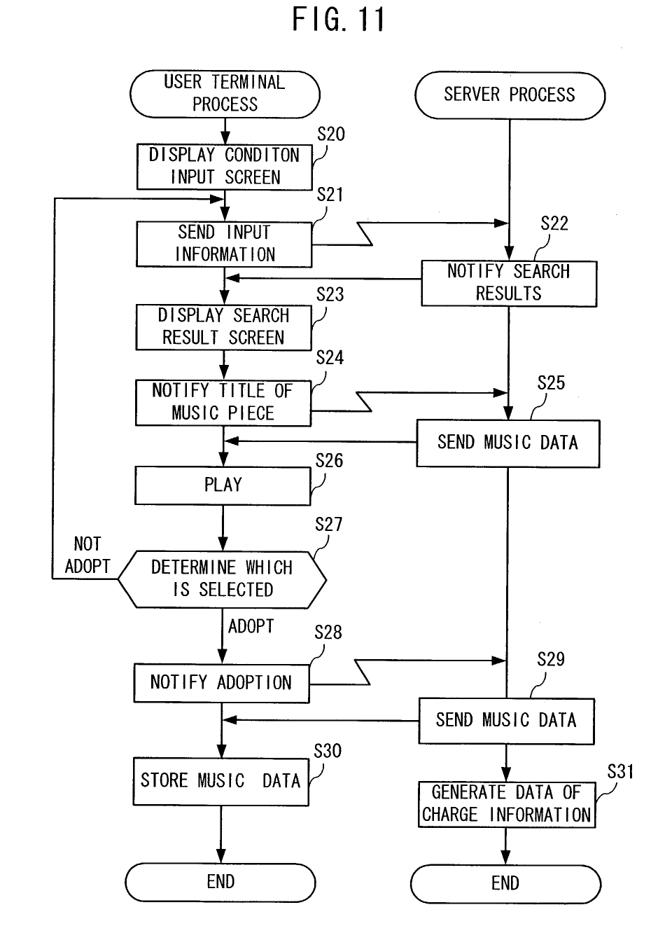

First, an operation of the information processing system 1 in a case where the user selects the “beginner's course” will be explained with reference to FIG. 11. The right hand of FIG. 11 shows processes performed by the server 30, and the left hand thereof shows processes performed by the user terminal 10 in accordance with the BGM/BGV creation assist application.

When the user clicks the “beginner's course” in the job selection screen shown in FIG. 10A using the mouse 14 of the user terminal 10, the user terminal 10 recognizes this and displays a screen shown in FIG. 10B for prompting he user to input job conditions (step S20). The user operates the user terminal 10 and inputs search conditions in each input section in the screen.

In this example, the user selects “this month's special” in the input section of “target BGM/BGV program”, and “chanson” in the input section of “genre”. Further, the user inputs “Paris” in the input section of “location” and “spring” in the input section of “season” in the “images”. Furthermore, the user selects “BGM only” in the “mode”. When the user clicks an “OK” button in the screen using the mouse 14 of the user terminal 10, the user terminal 10 sends information representing the search conditions to the control unit 31 of the server 30 (step S21).

The control unit 31 receives the information. The control unit 31 reads out a music corresponding to the search conditions from the music DB 40, by referring to the received information. The control unit 31 notifies the user terminal 10 of the search results (step S22).

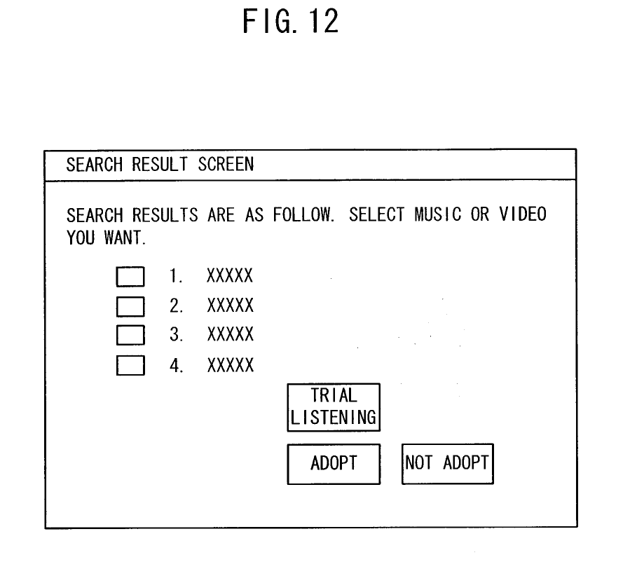

In response to this notification, the user terminal 10 displays a search-result screen shown in FIG. 12 on the display 13(step S23). When the user selects a desired music from the music shown on the display 13 and clicks a “trial listening” button using the mouse 14 of the user terminal 10, the user terminal 10 instructs the control unit 31 of the server 30 to send the data of music user selected (step S24).

In response to this instruction, the control unit 31 reads out music data of the user's desired music from the music DB 42 by referring to the received information, and sends the data to the user terminal 10 (step S25).

The user terminal 10 receives this music data and stores it into memory, etc,. Next, the user terminal 10 reproduces the music data in accordance with the BGM/BGV creation assist application (step S26). Therefore, the user can listen to the music he/she might buy for trial before he/she actually purchases it. At those steps, since this is a trial, it may be preferable to set up the server that the control unit 31 sends a part of music data to the user terminal 10.

After listening to the music, the user decides whether or not to adopt the music listened as trial. The user gives an instruction on the process to be executed next to the user terminal 10, by clicking an “adopt” button or “not adopt” button in the screen shown in FIG. 12, using the mouse 14. In response to this instruction, the user terminal 10 determines which one of the “adopt” button and the “not adopt” button is clicked (step S27).

In a case where determining that the “adopt” button is clicked (step S27: adopt button), the user terminal 10 notifies the control unit 31 of the server 30 that the user has selected “adopt” (step S28).

In response to this notification, the control unit 31 reads out the music data from the music DB 42 and sends the data to the user terminal 10 (step S29). The user terminal 10 receives the music data sent from the control unit 31 of the server 30, and stores the data in the HDD, etc (step S30). Then the user terminal 10 finishes the process. On the contrary, the control unit 31 create data of purchasing information such as a download log, stores it in the charge DB 45 (step S31), and finishes the process.

When determining in step S27 that the “not adopt” button has been clicked (step S27: not adopt), the user terminal 10 returns the process to step S21, and repeatedly performs the above process.

(Self-Creation Course)

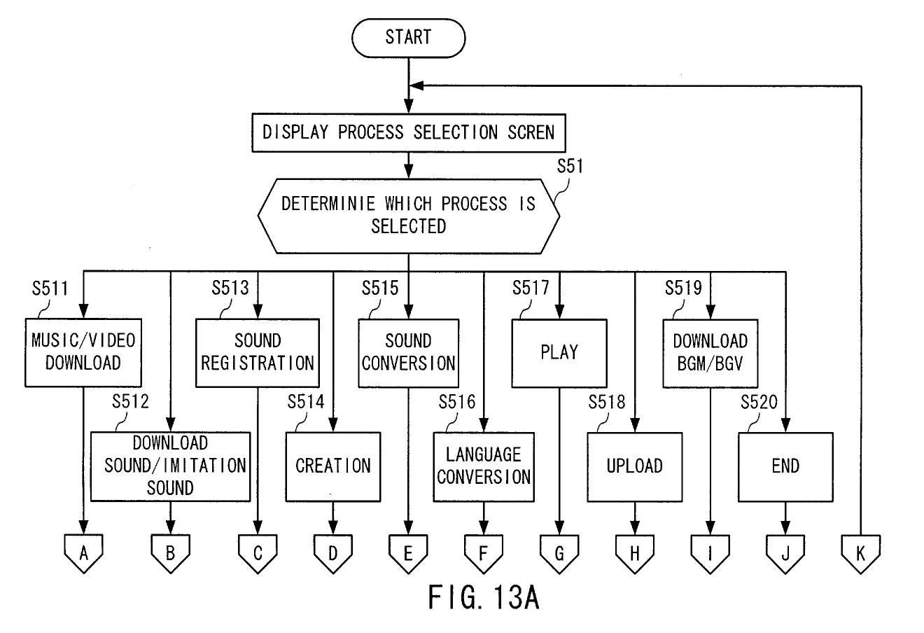

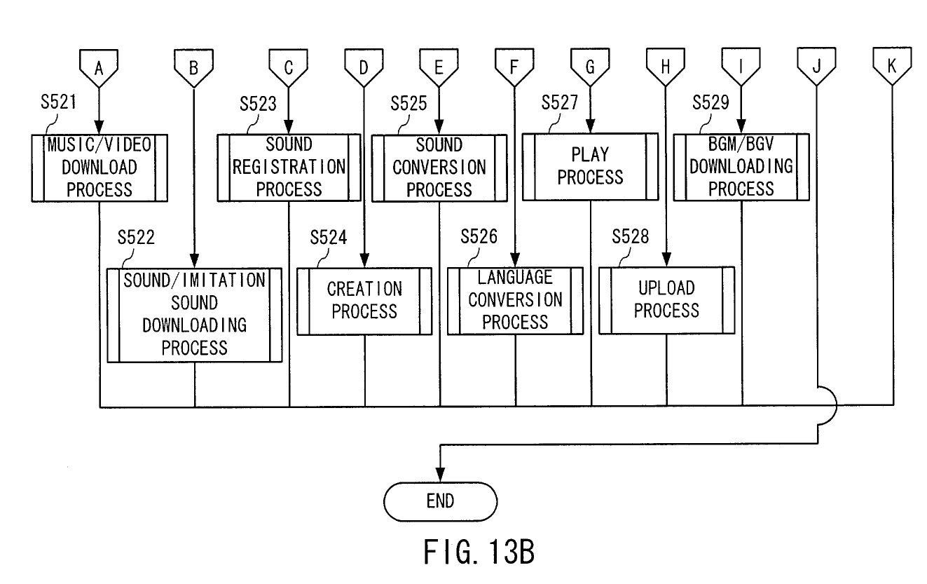

Next, an operation of the information processing system 1 when the user selects the “self-creation course” will be explained with reference to FIG. 13A and FIG. 13B. The flowchart shown in FIG. 13A and FIG. 13B shows processes performed by the user terminal 10.

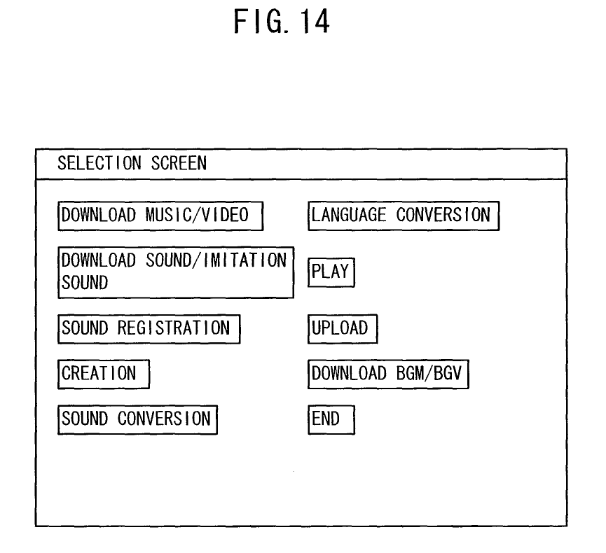

When the user clicks the “self-creation course” in the job selection screen shown in FIG. 10A using the mouse 14 of the user terminal 10, the user terminal 10 recognizes this and displays a screen shown in FIG. 14 for prompting the user to select a process on the display 13, in accordance with the installed BGM/BGV creation assist application (FIG. 13A, step S50). The user optionally clicks one of the buttons displayed in the screen shown in FIG. 14 using the mouse 14 of the user terminal 10 in order to select a process to be performed. The user terminal 10 determines which of the processes displayed in the screen is selected by the user's operation (step S51).

In a case where the user terminal 10 determines that the user has selected “download music/video” (FIG. 13A, step S511), the user terminal 10 performs a process for downloading music data or video data from the music DB 42 or the video DB 43 in the server 30 (FIG. 13B, step S521). In a case where the user terminal 10 determines that the user has selected “download sound/imitation sound” (FIG. 13A, step S512), the user terminal 10 performs a process for downloading sound data or imitation sound data from the sound DB 44 or from the imitation sound DB 46 in the server 30 (FIG. 13B, step S522).

In a case where the user terminal 10 determines that the user has selected “sound registration” (FIG. 13A, step S513), the user terminal 10 performs a process for uploading sound data created by the user in the sound DB 44 in the server 30 (FIG. 13B, step S523).

In a case where the user terminal 10 determines that the user has selected “creation” (FIG. 13A, step S514), the user terminal 10 performs a process for creating a BGM or BGV using music data or video data (FIG. 13B, step S524).

In a case where the user terminal 10 determines that the user has selected “sound conversion” (FIG. 13A, step 515), the user terminal 10 performs a process for converting arbitrary sound data stored in the sound DB 44 in to predetermined sound data (FIG. 13B, step S525).

In a case where the user terminal 10 determines that the user has selected “language conversion” (FIG. 13A, step S516), the user terminal 10 performs a process for converting arbitrary sound data stored in the sound DB 44 into a predetermined language (FIG. 13B, step S526).

In a case where the user terminal 10 determines that the user has selected “reproduce” (FIG. 13A, step S517), the user terminal 10 performs a process for reproducing music data or video data (FIG. 13B, step S527).

In a case where the user terminal 10 determines that the user has selected “upload” (FIG. 13A, step S518), the user terminal 10 performs a process for uploading BGM data or BGV data in the registered BGM DB 47 or the registered BGV DB 48 in the server 30 (FIG. 13B, step S528).

In a case where the user terminal 10 determines that the user has selected “download BGM/BGV” (FIG. 13A, step S519), the user terminal 10 performs a process for downloading BGM data or BGV data from the registered BGM DB 47 or the registered BGV DB 48 (FIG. 13B, step S529).

In a case where the user terminal 10 determines that the user has selected “end” (FIG. 13A, step S520), the user terminal 10 ends the BGM/BGV creation assist application. Details of the processes above are explained below separately.

(Self-Creation Course: Download Music/Video)

In this example, an operation of the information processing system 1 in a case where the user selects “download music/video”, will be explained.

In response to the user's clicking “download music/video” in the screen shown in FIG. 14 by the mouse 14, the user terminal 10 displays a screen for inputting title of music, title of video, genre, etc. on the display 13 in accordance with the application.

When the user inputs title of music, title of video, genre, etc. in the screen and gives an instruction to search data of the input music or video by operating the user terminal 10, this instruction is transmitted to the control unit 31 of the server 30.

In response to this instruction, the control unit 31 searches for the user's desired music data or video data in the music DB 42 or in the video DB 43. Then, the control unit 31 notifies the user terminal 10 of the search results.

In response to this notification, the user terminal 10 displays a list of search results on the display 13. When the user instructs to retrieve a desired music or video on the list by operating the user terminal 10, this instruction is transmitted to the control unit 31 of the server 30.

In response to this instruction, the control unit 31 reads out the user's desired music data or video data from the music DB 42 or the video DB 43.

The operation of the information processing system 1 after these processes is almost the same as the operation in the case where the user selects the “beginner's course” (FIG. 11, step S25 to step S31), therefore, explanation will be omitted.

After downloading is completed, the user terminal 10 displays screen shown in FIG. 14, on the display 13, and prompts the user to input an instruction.

(Self-Creation Course: Download Sound/Imitation Sound)

An operation of the information processing system 1 in a case where the user selects “download sound/imitation sound” will be explained.

When the user clicks “download sound/imitation sound” in the screen shown in FIG. 14 using the mouse 14 of the user terminal 10, the user terminal 10 displays a screen for inputting title of sound data or title of imitation sound data on the display 13.

The user inputs title of desired sound data or title of desired imitation sound data in the screen by operating the user terminal 10. When the user makes a request for retrieving sound data, etc., the user terminal 10 instructs the control unit 31 of the server 30 to search for the user's desired sound data or imitation sound data.

In response to this instruction, the control unit 31 searches for the user's desired sound data or imitation sound data in the sound DB 44 or in the imitation sound DB 46. Next, the control unit 31 reads out the searched-out data from the sound DB 44 or imitation sound DB 46, and sends them to the user terminal 10.

The user terminal 10 receives the data and stores it. Then, the user terminal 10 displays a screen showing a message that downloading has been completed on the display 13, and finishes this process.

The user terminal 10 displays the screen shown in FIG. 14 again, and prompts the user to input an instruction.

(Self-Creation Course: Sound Registration)

Here, an operation when the user selects “sound registration” will be explained.

First of all, the user pre-stores a sound of his/her own make in the HDD, etc. of the user terminal 10, using the sound devices 11 of the user terminal 10.

The user controls the user terminal 10 to display the screen shown in FIG. 14 on the display 13, by following the same procedure as described above. Then, the user clicks the “sound registration” button in the screen shown in FIG. 14.

The user terminal 10 responds the user's instruction, and displays a screen for inputting the title of the created sound data on the display 13. The user inputs the title of the sound data and gives an instruction to upload the sound data. In response to this, the user terminal 10 sends the sound data to the control unit 31 of the server 30.

The control unit 31 receives this data, and stores it in the sound DB 44. Next, the control unit 31 notifies the user terminal 10 that registration of the user's sound data has been completed.

In response to this notification, the user terminal 10 displays a screen indicating that registration of the sound data has been completed on the display 13. Then, the user terminal 10 ends the “sound registration” process, and displays the screen shown in FIG. 14 on the display 13 again.

Voice of which the registered sound data represent is coded by the organizer of the server 30 so that the data will be available for “sound conversion” and “language conversion”. After coding, the organizer let the user know that the registered sound data is available for sound conversion and language conversion by, for example, email.

(Self-Creation Source: Creation)

Next, an operation when the user selects “creation” will be explained by employing a case of creating a BGM as an example.

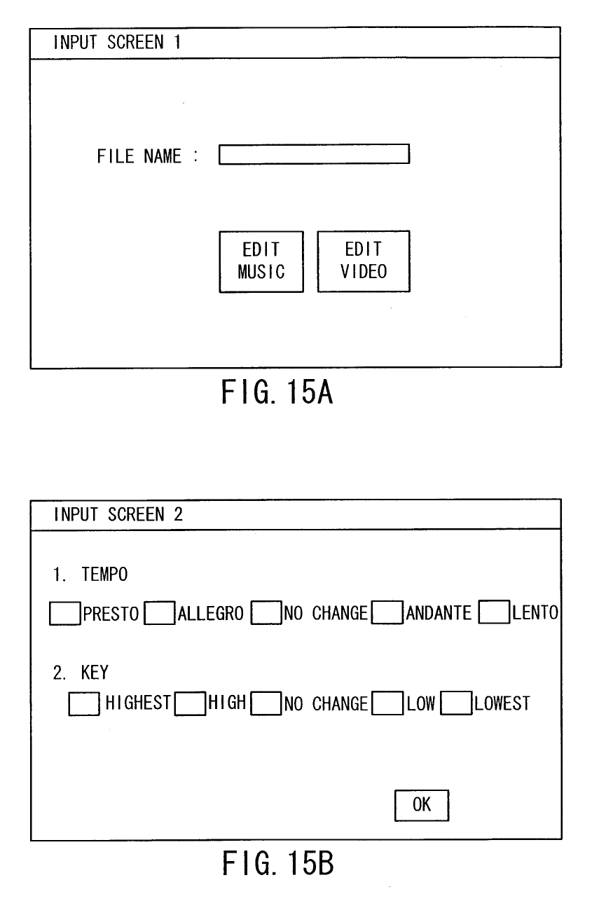

When the user clicks “creation” in the screen shown in FIG. 14 using the mouse 14, the user terminal 10 displays an input screen 1 shown in FIG. 15A having an input section for “file name” (title of a data), a “edit music” button and a “edit video” button on the display 13, in accordance with the application. The user inputs a title of a data by the keyboard 15 and clicks the “edit music” button by the mouse 14. In response to this, the user terminal 10 which operates under the control of the application displays an input screen 2 shown in FIG. 15B which prompts the user to designate a tempo and a key on the display 13.

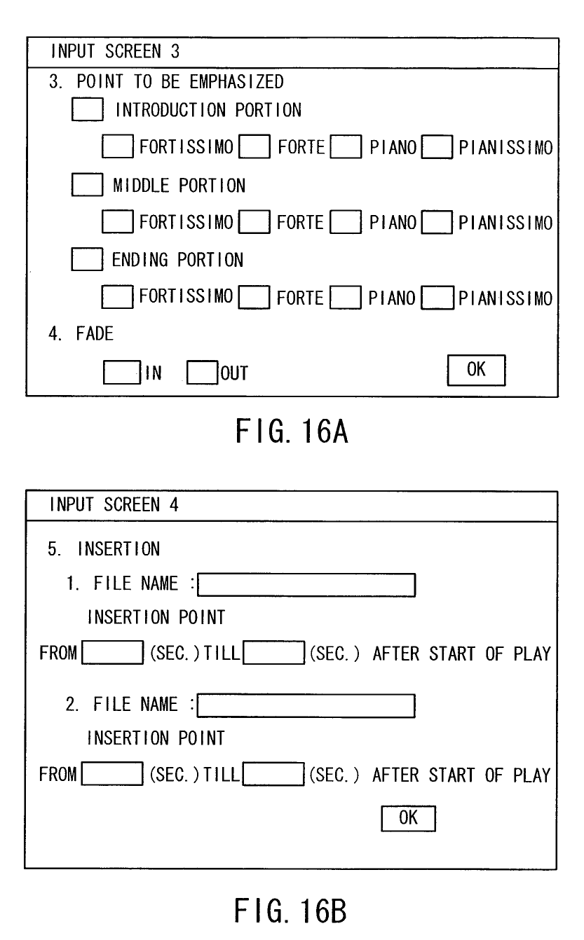

The user designates a tempo and a key by operating the user terminal 10. Next, the user clicks an “OK” button in the screen shown in FIG. 15B using the mouse 14 of the user terminal 10. By the user's clicking the “OK” button, the user terminal 10 displays an input screen 3 shown in FIG. 16A for setting fading, etc. on the display 13.

The user designates fading, etc. for the music designated on the screen shown in FIG. 15A by operating the user terminal 10. Next, the user clicks an “OK” button in the screen shown in FIG. 16A using the mouse 14. By this user's operation, the user terminal 10 displays a screen shown in FIG. 16B for letting the user to select a sound or imitation sound, etc. to be inserted.

By operating the user terminal 10, the user inputs a name of sound data or imitation data to be input into the music designated on the screen shown in FIG. 15A. Further, the user designates the point into which the sound or imitation sound will be inserted (the insertion point is designated by, in this example, the playing time of the music). The user clicks an “OK” button in the screen shown in FIG. 16B using the mouse 14 of the user terminal 10. In response to this user's operation, the user terminal 10 starts creating a BGM or BGV.

Specifically, the user terminal 10 first reads out the music data designated on the screen shown in FIG. 15A from the HDD, etc. Next, the user terminal 10 changes the read-out music data in accordance with the tempo and key designated on the screen shown in FIG. 15B. Then, the user terminal 10 changes the fading, etc. of the music data which has been changed with respect to its tempo and key, in accordance with the user's designations input in the screen shown in FIG. 16A. Sequentially, the user terminal 10 inserts the sound data or imitation sound data designated on the screen shown in FIG. 16B into the music data. When the editing is completed and thus creation of a BGM is finished, the user terminal 10 ends the “creation” process, and displays the screen shown in FIG. 14 on the display 13 again.

(Self-Creation Course: Sound Conversion)

Next, an operation of the information processing system 1 when the user selects “sound conversion” will be explained.

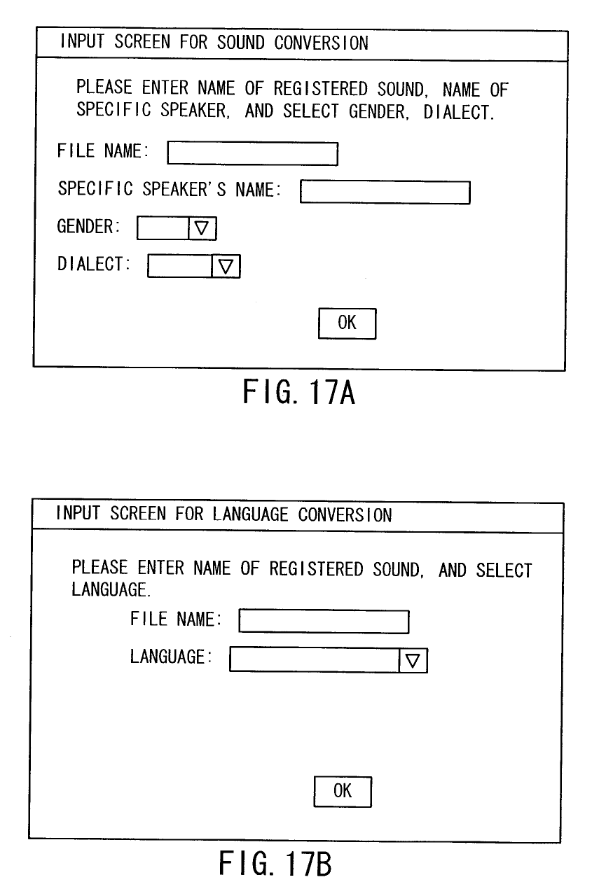

When the user clicks “sound conversion” button in the screen shown in FIG. 14 using the mouse 14, the user terminal 10 displays an input screen shown in FIG. 17A having input sections for “file name” (name of sound data), “specific speaker's name”, “gender”, and “dialect”, in accordance with the application. The user inputs one of the following or any combinations of them: a name of sound data; a specific speaker's name; gender; or a specific dialect; by operating the user terminal 10 and clicks an “OK” button by the mouse 14. In response to this, the user terminal 10 sends the information input by the user to the control unit 31 of the server 30.

The control unit 31 receives the information. Next, the control unit 31 searches for any sound data that corresponds to the user's designations shown by the received information in the sound DB 44. The control unit 31 reads out the searched-out sound data from the sound DB 44 and sends it to the sound conversion unit 35. At the same time, the control unit 31 instructs the sound conversion unit 35 to perform sound conversion.

The sound creation unit 60 of the sound conversion unit 35 receives the sound data and starts one of the following processes or any combination of them in accordance with the given instruction.

The sound creation unit 60 shown in FIG. 4 searches for each code of the specific speaker's voice that corresponds to each code of the sound data in the specific speaker's voice memory 61, and reads it out. Then, the sound creation unit 60 converts the sound data into the specific speaker's voice data by combining each of the codes, which have been read out.

The sound creation unit 60 searches for each code of a male voice or female voice that corresponds to each code of the received sound data in the male voice memory 62 or in the female voice memory 63, and reads it out. Sequencially, the sound creation unit 60 converts the sound data into male voice data or female voice data by combining the read-out codes.

The sound creation unit 60 searches for each code of a specific dialect that corresponds to each code of the received sound data in the dialect voice memory 64, and reads it out. Sequentially, the sound creation unit 60 converts the sound data into the specific dialect voice data, by combining the read-out codes.

The sound creation unit 60 then sends the sound-converted data to the control unit 31.

The control unit 31 receives the sound-converted data, and sends it to the user terminal 10. The user terminal 10 receives the data and displays a message that the sound conversion process has been completed on the display 13. Then, the user terminal 10 finishes the “sound conversion” process and displays the screen shown in FIG. 14 on the display 13 again. The control unit 31 also finishes the “sound conversion” process after completing sending the sound data, and waits instructions for another processes.

(Self-Creation Course: Language Conversion)

Next, an operation of the information processing system 1 when the user selects “language conversion” will be explained.

By the user's clicking “language conversion” in the screen shown in FIG. 14 using the mouse 14, the user terminal 10 displays an input screen shown in FIG. 17B having an input section for “file name” (name of sound data) and a section for designating “language” on the display 13 in accordance with the application. The user inputs a sound data name, designates a language into which the user requests his/her data to be converted, and clicks an “OK” button by the mouse 14. In response to this, the user terminal 10 sends information for specifying the sound data and the language or the dialect which the user desire, to the control unit 31 of the server 30.

The control unit 31 receives the information. Then, the control unit 31 searches for sound data corresponding to the user's designated one in the sound DB 44. The control unit 31 reads out the searched-out sound data from the sound DB 44, and gives it to the automatic translation unit 36 for language conversion. The automatic translation unit 36 converts the language of the sound data into a specific language under the control of the control unit 31.

More specifically, upon receiving the sound data, the language process unit 65 of the automatic translation unit 36 shown in FIG. 5 identifies a plurality of words in the received sound data by referring to the word dictionary 68, and outputs them to the language conversion unit 66. The language conversion unit 66 receives the plurality of words, and analyzes the words with respect to structure and meaning by referring to language rules stored in the original language information file 69. Then, the language conversion unit 66 converts the plurality of words into a word stream that makes a sense as a sentence, and outputs the word stream to the translated language generation unit 67. The translated language generation unit 67 receives the word stream from the language conversion unit 66, and an instruction from the control unit 31. In response to this instruction, the translated language generation unit 67 extracts a word of the translating language which corresponds to a word of the word stream from the language conversion unit 66 by referring to the translated word dictionary 70. Next, the translated language generation unit 67 arranges the extracted words to a word stream in accordance with language rules stored in the translated language information file 71, thereby generates a translated sound data. The translated language generation unit 67 outputs the translated sound data to the control unit 31.

The control unit 31 receives the language-converted sound data from the translated language generation unit 67 of the automatic translation unit 36, and sends it to the user terminal 10. The user terminal 10 receives this sound data, and stores it in the HDD, etc. Then, the user terminal 10 displays a message that the language conversion process has been completed on the display 13. The user terminal finishes the “language conversion” process, and displays the screen shown in FIG. 14 on the display 13 again.

(Self-Creation Course: Play)

Next, an operation of the information processing system 1 when the user selects “play” (reproduce) will be explained.

When the user clicks “play” in the screen shown in FIG. 14 using the mouse 14, the user terminal 10 displays an input screen for letting the user designate music data or video data to be reproduced on the display 13. The user inputs the name of the data that the user wants to reproduce in this input screen by operating the user terminal 10. The user terminal 10 reproduces the data designated by the user in accordance with the BGM/BGV creation assist application. After data reproduction, the user terminal 10 finishes the reproduction process, displays the screen shown in FIG. 14 on the display 13 again, and waits for the next instruction to be input by the user.

(Self-Creation Course: Upload)

Next, an operation of the information processing system 1 when the user selects “upload” will be explained.

By the user's clicking “upload” in the screen shown in FIG. 14 using the mouse 14 of the user terminal 10, the user terminal 10 searches for a BGM or BGV which the user has created in HDD, etc. Next, the user terminal 10 displays a list of search results on the display 13.

The user designates data that he/she wants to upload from the displayed list and inputs an instruction for transferring the designated data to the server 30 by operating the user terminal 10. In response to this, the user terminal 10 sends the user's selected data to the control unit 31 of the server 30.

The control unit 31 receives this data, and stores it in the registered BGM DB 47 or in the registered BGV DB 48. Further the control unit 31 stores the name of the stored data in the management DB 40 in association with the member ID. Then, the control unit 31 notifies the user terminal 10 that uploading has been completed.

In response to this notification, the user terminal 10 displays a screen showing that uploading has been completed on the display 13. Then, the user terminal 10 finishes the uploading process, and displays the screen shown in FIG. 14 on the display 13.

The data uploaded in the server 30 can be used as, for example, backup data.

(Self-Creation Course: Download BGM/BGV)

Next, an operation of the information processing system 1 when the user selects “download BGM/BGV” will be explained.

When the user clicks “download BGM/BGV” in the screen shown in FIG. 14 using the mouse 14 of the user terminal 10, the user terminal 10 recognizes this. The user terminal 10 displays a screen having input sections for file names (title of a BGM or BGV), and a “send” button for instructing sending of input information. The user inputs the name of a BGM or BGV, which he/she wants to retrieve in the screen by operating the user terminal 10. When the user clicks the “send” button using the mouse 14, the user terminal 10 sends the input information to the control unit 31 of the server 30.

The control unit 31 receives the information. Then, the control unit 31 searches for the user's desired BGM or BGV data in the registered BGM DB 47 or in the registered BGV DB 48 based on the received information, and reads it out. The control unit 31 sends the read-out BGM data or BGV data to the user terminal 10. The user terminal 10 receives this data and stores it in the HDD, etc. Then, the user terminal 10 notifies the user via the message that downloading is complete. The user terminal 10 finishes the “downloading process”, displays the screen shown in FIG. 14 on the display 13 again, and prompts the user to select the next instruction. The control unit 31 also finishes the “download process” and waits another instruction.

As described above, according to the present invention, the server 30 obtains information regarding the capacities of the hardware and software of the user terminal 10 from the user terminal 10. The server 30 specifies a BGM /BGV creation assist application which can be operable with the hardware and software of the user terminal 10, based on the obtained information. The server 30 provides the specified BGM/BGV creation assist application to the user terminal 10. By using this BGM/BGV creation assist application, the user can retrieve contents such as a music and a video from the server 30, and also can edit the obtained contents. Therefore, the user can easily create his/her unique BGM or BGV using contents obtained from the server 30 as materials.

The present invention is not limited to the above-described embodiment. For example, the layouts of the screens for prompting the user to do some operations such as inputting, are mere examples. Therefore, any layouts are acceptable as long as they achieve the same effects. Further, the same goes for the procedure of displaying each screen.

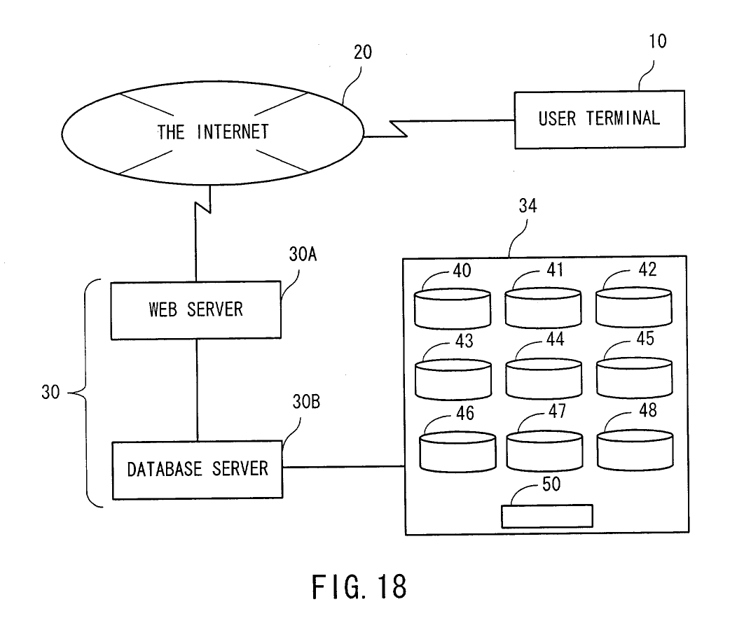

As shown in FIG. 18, the server 30 may be constituted by a web server 30A and a database server 30b having the information storage unit 34. In this case, the web server 30A may include a web server application, an external application such as Peal, a module such as PHP, a database interface, etc. Further, the database server 30B may include a DBMS, etc.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-47230 filed on Feb. 22, 2002 and including specification, claims, drawings and summary. The disclosure of the above Japanese Patent Application is incorporated herein by reference in its entirety.

What is claimed is:

1. An information processing system which is constituted by a plurality of clients and an information processing apparatus connected to said clients through a network, and which distributes contents from said information processing apparatus to said clients in response to a request from said each client, said information processing apparatus comprising:
an information storage unit which stores contents and a plurality of applications, the applications being authoring tools for editing the contents, and having different operational conditions from one another in accordance with capacities of hardware and software; and
a control unit which distributes contents stored in said information storage unit to said each client in response to the request, obtains information representing capacities of hardware and software of each said client,
wherein said control unit:
specifies any of the applications operable with the hardware and the software of each said client by an information for specifying the capacities of the hardware and the software of each said client, sent from said each client; and
reads out the specified application from said information storage unit, and provides the specified application to each said client.

2. The information processing system according to claim 1,
wherein said information storage unit stores contents protected by copyrights, and said control unit charges royalty of the contents protected by copyrights to a user identified by an in formation sent from said client, in case that the user obtains the contents protected by copyrights.

3. The information processing system according to claim 1, said information processing apparatus further comprising a sound conversion unit for converting a quality of a voice represented by a sound data,
wherein said control unit obtains a sound data representing a voice of a user of each said client, controls said sound conversion unit to convert the quality of the voice in accordance with an instruction from each said client, and sends converted sound data to instructing client.

4. The information processing system according to claim 1 said information processing apparatus further comprising an automatic translation unit for converting an expression of a voice represented by sound data to predetermined language expression,
wherein said control unit obtains the sound data representing a voice of a user of each said client, controls said automatic translation unit to convert the expression of the voice to predetermined language expression in accordance with an instruction from each said client, and sends converted sound data to instructing client.

5. The information processing system according to claim 1,
wherein said control unit obtains contents edited by one of said clients operating with said application and sent from the one of said clients, stores the contents into said information storage unit, reads out the contents from said information storage unit in accordance with a request from the other of said clients and sends read-out contents to the other of said clients requested obtaining the contents.

6. An information processing apparatus connected to a plurality of clients through a network, said apparatus comprising:
an information storage unit which stores contents and a plurality of applications, the applications being authoring tools for editing contents and having different operational conditions from one another in accordance with capacities of hardware and software;
a control unit which receives device information sent from each said client for specifying capacities of hardware and software of each said client, reads out any of the applications operable with the capacities of the hardware and the software of each said client from said information storage unit based on the received device information, and sends the application to each said client;
wherein said control unit:
(a) receives content specifying information for specifying a content sent from each said client operating with the transmitted application; and
(b) reads out a specific content from said information storage unit based on the received content specifying information; and
(c) sends the specified content to each said client.

7. The information processing apparatus according to claim 6,
wherein said information storage unit stores contents protected by copyright and said control unit charges royalty of the contents protected by copyrights to a user identified by an information sent from said client, in case that the user obtains the contents protected by copyrights.

8. The information processing apparatus according to claim 6, wherein said information storage unit stores contents edited by one of said clients operating with the application and sent from the one of said clients, and said control unit reads out stored contents from said information storage unit in response to a request from the other of said clients and sends the read-out contents to the other of said clients.

9. The information processing apparatus according to claim 6, further comprising a sound conversion unit for converting a quality of a voice represented by a sound data,
wherein said control unit:
(a) obtains a sound data representing a human voice from each said client;
(b) stores the obtained sound data into said information storage unit;
(c) reads out the sound data from said information storage unit and give the sound data to said sound conversion unit;
(d) controls said sound conversion unit to converts the quality of the voice represented by the sound data in accordance with an instruction sent from each said client; and
(e) sends the sound data which has been sound-converted by said first sound conversion means to each said client which has sent the instruction.

10. The information processing apparatus according to claim 6, further comprising an automatic translation unit for converting an expression of a human voice represented by a sound data to predetermined language expression,
wherein said control unit;
(a) obtains a sound data representing a human voice from each said client;
(b) stores the sound data into said information storage unit;
(c) reads out the sound data from said information storage unit in accordance with an instruction sent from each said client and gives the sound data to said automatic translation unit;
(d) controls said automatic translation unit to convert the expression of the voice of the read-out sound data to predetermined language expression in accordance with the instruction;
(e) sends the sound data which has been sound-converted by said second sound conversion means to each said client which has sent the instruction.

11. An information processing method which is applied to an information processing apparatus existing on a network and connected to a plurality of clients through said network, said method comprising:
storing contents and a plurality of applications which are authoring tools for editing contents and have different operational conditions from one another in accordance with capacities of hardware and software;
obtaining information for specifying capacities of hardware and software of each said client from each said client;
specifying any of the applications that is operable with the capacities of the hardware and software of each said client based on the information and sending the application to each said client;
obtaining information for specifying a content from each said client; and
sending the content specified by the information to each said client which has sent the information.

12. The information processing method according to claim 11, further comprising:
storing contents protected by copyright; and
charging royalty of the contents protected by copyrights to a user identified by an information sent from said client, in case that the user obtains the contents protected by copyrights.

13. The information processing method according to claim 11, further comprising:
obtaining sound data representing a human voice from each said client;
converting a quality of the voice represented by the sound data in accordance with an instruction sent from each said client which operates in accordance with the application; and
sending the sound-converted sound data to each said client which has sent the instruction.

14. The information processing method according to claim 11, further comprising:
obtaining sound data representing a human voice from each said client;
converting an expression of said voice to predetermined language expression in accordance with an instruction from each said client which operates in accordance with the application.

15. The information processing method according to claim 11, further comprising:
obtaining contents which have been edited by the application and which are sent from one of said clients;
storing the contents obtained;
obtaining an instruction of sending the contents from the other of said client; and
sending the contents to the other of said clients.

16. A program which is applied to an information processing apparatus connected to a plurality of clients through a network, for distributing contents to said clients at a request, said program controlling said information processing apparatus to execute processes for:
obtaining information for specifying capacities of hardware and software of each said client from each said client;
specifying any of the applications which are authoring tools for editing contents and have different operational conditions from one another in accordance with capacities of hardware and software, operable with the capacities of the hardware and software of each said client based on the information,
sending the application to each said client;
obtaining information for specifying a content from each said client; and
sending the content specified by the information to each said client which has sent the information.

17. The program according to claim 16, further controlling said information processing apparatus to execute processes for:
obtaining contents which have been edited by the application and which are sent from one of said clients;
storing the contents obtained;
obtaining an instruction of sending the contents from the other of said clients; and
sending the contents to the other of said clients.

18. The program according to claim 16, further controlling said information processing apparatus to execute processes for:
obtaining sound data representing a human voice from each said client;
converting a quality of the voice represented by the sound data in accordance with an instruction sent from each said client which operates in accordance with the application; and
sending the converted sound data to each said client which has sent the instruction.

19. The program according to claim 16, further controlling said information processing apparatus to execute processes for:
obtaining sound data representing a human voice from each said client;
converting an expression of said voice to predetermined language expression in accordance with an instruction from each said client which operates in accordance with the application.

20. The program according to claim 11, further said information processing apparatus to execute a process for charging royalty of the contents protected by copyrights to a user identified by an information sent from said client, in case that the user obtains the contents protected by copyrights.

21. An information processing system which is constituted by a plurality of clients and an information processing apparatus connected to said clients through a network, and which distributes contents from said information processing apparatus to said clients in response to a request from said client, said information processing apparatus comprising:
means for obtaining information showing capacities of hardware and software of each said client;
means for storing a plurality of applications which are authoring tools for editing the contents, and which have different operational conditions from one another in accordance with capacities of hardware and software; and
providing means for specifying any of the applications which can be operated on the hardware and software of each client, and providing the specified application to each said client.

22. An information processing apparatus connected to a plurality of clients through a network, said apparatus comprising:
first storage means for storing a plurality of applications which are authoring tools for editing contents and have different operational conditions from one another in accordance with capacities of hardware and software;
first reception means for receiving device information for specifying capacities of hardware and software of each said client which information is notified by each said client;
first sending means for reading out any of the applications that is operable with by the capacities of the hardware and software of each said client from said first storage means based on the received device information, and sending the application to each said client;
second storage means for storing contents;
second reception means for receiving content specifying information for specifying a content which information is notified by each said client which operates in accordance with the transmitted application; and
second sending means for reading out the specific content from said second storage means based on the received content specifying information, and sending the content to each said client.
